(19) United States
(12) Patent Application Publication
(10) Pub. No.: US 2002/0114896 A1
(43) Pub. Date: Aug. 22, 2002

(54) System and method for curing reactive material

(76) Inventors: John Kennedy, Guelph (CA); John Kuta, Mississauga (CA); Eduardo Ghelman, Etobicoke (CA); Roy Kayser, Burlington (CA); Chris Dimas, North York (CA); Manfred Hubert, Don Mills (CA); Steve Martin, Toronto (CA)

Correspondence Address: Shawn D. Jacka, Bereskin & Parr, Box 401, 40 King Street West, Toronto, ON, M5H 3Y2, CA

(21) Appl. No.: 09/904,482

(22) Filed: Jul. 16, 2001

Related U.S. Application Data
(63) Continuation-in-part of application No. 09/846,237, filed on May 2, 2001.
(60) Provisional application No. 60/269,864, filed on Feb. 21, 2001.
(60) Provisional application No. 60/276,140, filed on Mar. 16, 2001.

(51) Int. Cl. B05D 3/02

(52) U.S. Cl. 427/487

(57) ABSTRACT

A method and system for curing reactive material. The system includes a generator capable of generating radiation, a power supply operatively coupled to the generator, and an emitter adapted to emit the generated radiation onto the material. The system also includes a temperature sensor capable of detecting the temperature of the material a controller adapted to control the power level of radiation emitted. The system also preferably includes a masking unit for shaping the emitted radiation to substantially match the profile dimensions of the reactive material. In one embodiment, the method includes the steps of generating radiation within the absorption spectrum of the reactive material; shaping the generated radiation to substantially match the dimensions of the reactive material; and emitting said shaped radiation onto the reactive material. In another embodiment, the method comprises the steps of generating radiation; directing radiation at a first power level onto the reactive material for a first period of time; and directing radiation at a second power level onto the reactive material for a second period of time.

### CROSS-REFERENCE TO RELATED APPLICATIONS

This application claims the benefit of Provisional Applications Serial No. 60/276,140, filed Mar. 16, 2001 and Serial No. 60/269,864, filed Feb. 21, 2001, and Utility patent application Ser. No. 09/846,237, filed May 2, 2001.

### FIELD OF THE INVENTION

The present invention relates generally to the field of curing polymeric materials, typically in the class of thermosets, with common but by no means exclusive application to manufacturing techniques involving reactive adhesives. For greater clarity, when used herein, “curable materials” and variations thereof are intended to mean polymeric materials which chemically transform with the application of sufficient energy, unless a contrary intention is apparent.

### BACKGROUND OF THE INVENTION

Curable materials, such as photoreactive adhesives, are commonly used in manufacturing applications. The process of curing such reactive materials generally involves the supplying of energy to the reactive material to initiate the desired chemical reaction.

Prior art techniques for curing adhesives, particularly in the manufacture of microelectronic and optoelectronic components, typically involve placing the entire component in an oven and heating the component until the adhesive is sufficiently cured. However, the rate at which curing can be effected is limited by the maximum temperature that the entire component can withstand without thermal damage. Furthermore, energy is wasted heating the entire component, when only the curable material requires heat energy for curing.

Accordingly, the inventors have recognized a need for a system and method which are capable of efficiently curing reactive adhesives and other small quantities of curable material.

### SUMMARY OF THE INVENTION

This invention is directed towards a system for curing reactive material.

The system comprises a generator capable of generating radiation within the absorption spectrum of the reactive material, an emitter adapted to focus the generated radiation and emit said focused radiation onto the reactive material, a power supply operatively coupled to the generator, and a controller adapted to control the amount of power supplied to the generator. Preferably, the emitter also includes a mask for shaping the cross-sectional beam profile of the emitted radiation to substantially match the shape of the reactive material to be cured.

The invention is also directed towards a method for curing reactive material. The method comprises the steps of:

(a) generating radiation within the absorption spectrum of the reactive material;

(b) focusing the generated radiation; and

(c) emitting said focused radiation onto the reactive material.

Preferably, the method also includes the step of shaping the cross-sectional beam profile of the emitted radiation to substantially match the shape of the reactive material. Additionally, the method also preferably includes the step of varying the power of the emitted radiation to substantially match a curing profile for the reactive material. As will be understood, “curing profile” as used herein is intended to mean curing parameters such as power level and duration of cure, which will satisfactorily cure a specified quantity of a particular reactive material. It will also be understood that a quantity of reactive material may have more than one curing profile.

In addition, the invention is directed towards an additional method for curing reactive material. This method comprises the steps of:

(a) generating radiation;

(b) directing radiation at a first power level onto the reactive material for a first period of time; and

(c) directing radiation at a second power level onto the reactive material for a second period of time.

### BRIEF DESCRIPTION OF THE DRAWINGS

The present invention will now be described, by way of example only, with reference to the following drawings, in which like reference numerals refer to like parts and in which:

FIG. 1 is a side perspective view of the integrated system made in accordance with the present invention.

FIG. 2 is a cross-sectional schematic diagram of the light delivery module of FIG. 1.

FIG. 3 is a side view of the light delivery module of FIG. 1.

FIG. 4A is side view of a lens and masking unit for use with the light delivery module of FIG. 1.

FIG. 4B is a schematic representation of the optical train of the lens and masking system of FIG. 4A.

FIG. 4C is a side view of the lens and masking system of FIG. 4A mounted to the light delivery module of FIG. 1.

FIG. 5 is a logical flow diagram of a curing method carried out by the curing system made in accordance with the present invention.

FIG. 6 is a plot of irradiance as a function of the lateral displacement for different mask diameters.

FIG. 7 is the infrared optical transmission spectrum of epoxy Epotek 353.

FIG. 8 is a logical flow diagram of a multi-step curing method carried out by the curing system made in accordance with the present invention.

### DESCRIPTION OF THE PREFERRED EMBODIMENTS

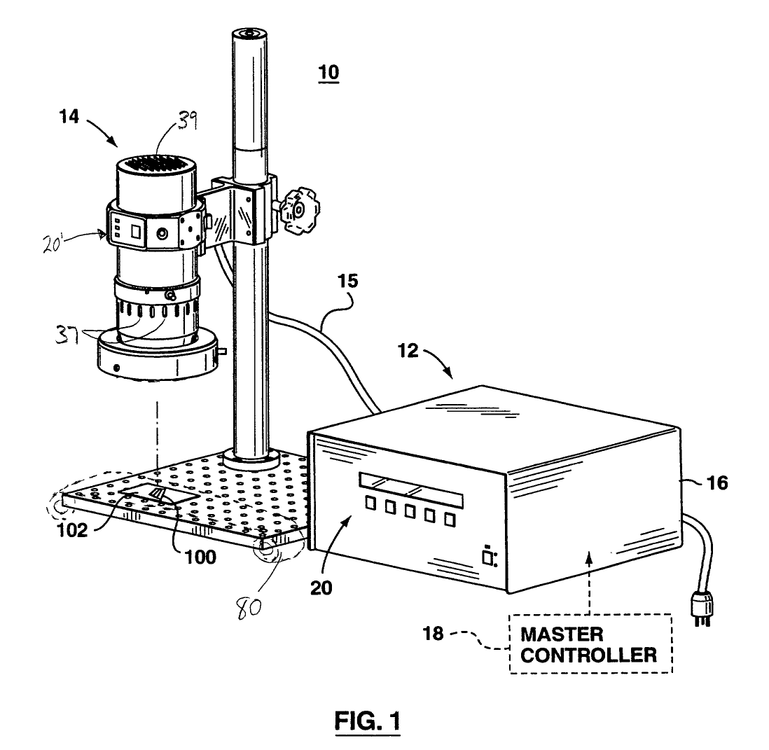

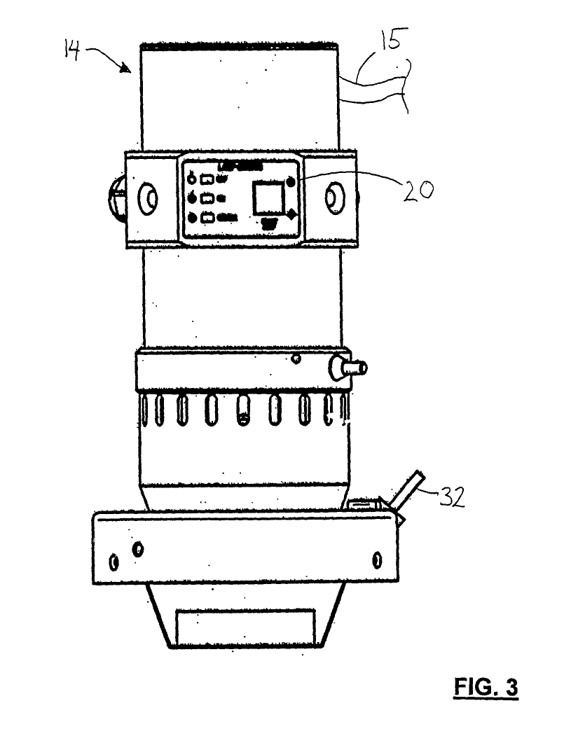

Referring simultaneously to FIGS. 1, 2 and 3, illustrated therein is a preferred embodiment of the curing system of the subject invention. The curing system, shown generally as 10, comprises a base unit 12 and a light delivery module 14 (LDM). The base unit 12 and the light delivery module 14 are operatively coupled together by cabling 15 to enable the exchange of data and the supply of power from the base unit 12 to the LDM 14, as will be discussed in greater detail, below.

The base unit 12 includes a base unit housing 16, a master controller 18 and a control data interface 20 having keypads and a display for enabling a user to input control instructions and data into the system 10 via the master controller 18. The master controller 18 contains a suitably programmed central processing unit and memory, as will be understood.

The module 14 includes a housing 26 containing the LDM controller 28, a power supply 30, a non-contact worksite temperature sensor 32, a light source or generator 34, an internal temperature sensor 36, a fan 38 and an emitter assembly 40. The module 14 also comprises air intake louvers 37 and an upper exhaust vent 39 to enable the fan 38 to draw external air over the internal components of the module 14 for cooling. Preferably the louvers 37 and vent 39 are configured such that the airflow directs fumes and other contaminants released during the curing cycle away from the emitter assembly 40. The LDM 14 may also comprise an LDM control data interface 20′ operatively connected to the LDM controller 28, having keypads and a display for enabling a user to input control instructions and data into the system 10. The LDM control data interface 20′ may display operational information to the user, including the status of the light source 34.

The power supply 30 is configured to provide power to the light source 34, and typically is electrically coupled to the base unit 12 which in turn obtains power through a standard electrical plug. In turn, the LDM controller 28 is operatively coupled to the power supply 30 and to the light source 34, to control the supply of power to the light source 34 throughout a curing cycle.

Preferably the light source 34 is configured to generate broad-band infrared radiation, and typically includes a tungsten halogen lamp. As will be understood, the light source 34 also includes a reflector often coated with gold or aluminum to reflect light having longer wavelengths.

The emitter assembly 40 includes a lens 41 for focusing the generated light radiation onto the curable material 100 positioned on the workpiece 102 at the focal point. Preferably the lens is made of calcium fluoride or other material which is capable of transmitting a broad range of infrared wavelengths. The emitter assembly 40 also preferably includes an exchangeable filter 42 for enabling the selective emission of specific spectral bands of radiation that can be more precisely matched to the absorption spectrum of the material to be cured. Preferably, exchangeable filters 42 will be provided having passbands falling within the spectral range of 0.4 to 10 micrometers, and more preferably within the range of 0.6 and 5 micrometers. As well, the emitter assembly 40 may also include a shutter mechanism 43 for regulating the amount of energy emitted by the LDM 14, in place of regulating the power to the light source 34.

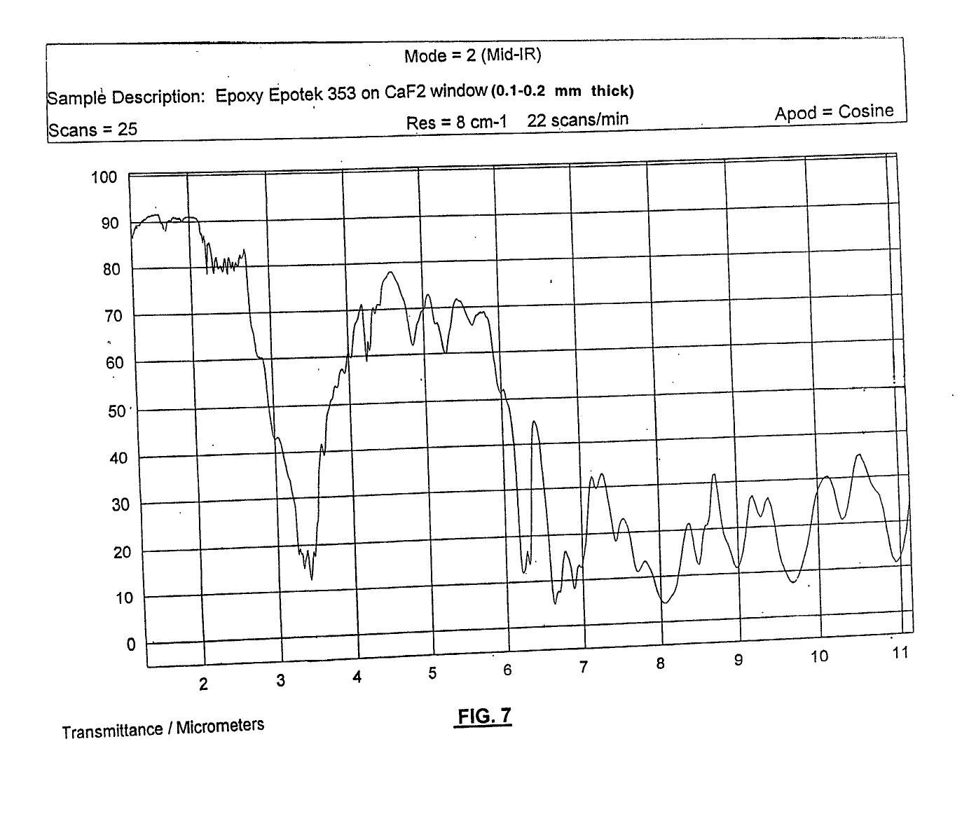

For applications involving most types of curable adhesives, preferably the light source 34 and emitter 40 are selected to respectively generate and emit infrared radiation in the range of 0.4 to 10 micrometers, and more preferably within the range of 3 to 5 micrometers. This 3 to 5 micrometer range largely overlaps the high absorption region of a large number of curable materials, including many adhesives. As illustrated on FIG. 7, the transmittance rate of one such adhesive, epoxy Epotek 353, shows a strong absorption at approximately 3.5 micrometers. Other relatively high absorption rates for the adhesive in the mid-infrared range are also indicated on FIG. 7. As will be understood, radiant energy of non-ionizing wavelengths substantially falling within the absorption spectrum of the curable material 100 is immediately transformed into thermal energy, thereby heating and curing the curable material 100.

The LDM controller 28 is operatively linked to the master controller 18, and is also electrically connected to the non-contact worksite temperature sensor 32. The non-contact temperature sensor 32 is configured to monitor the temperature of the curable material 100 throughout the cure cycle. The temperature sensor 32 typically monitors blackbody radiation, which is proportional to the temperature, emitted by the curable material 100, and generates corresponding temperature data which is received by the LDM controller 28. This data may be used by the LDM controller 28 to control the duration of the curing cycle and the power levels of the generated (and emitted) radiation during the curing cycle in accordance with stored curing parameters. As will be understood, the LDM 14 may include a detector (preferably non-contact) for tracking or monitoring the degree of cure of the curable material during a curing cycle, in place of or in addition to the non-contact temperature sensor 32. With such a configuration, preferably the non-contact detector is adapted to generate data signals correlated to the detected degree of cure. This degree of cure data may be used by the LDM controller 28 to control the duration of the curing cycle and the power levels of the generated (and emitted) radiation during the curing cycle in accordance with stored curing parameters.

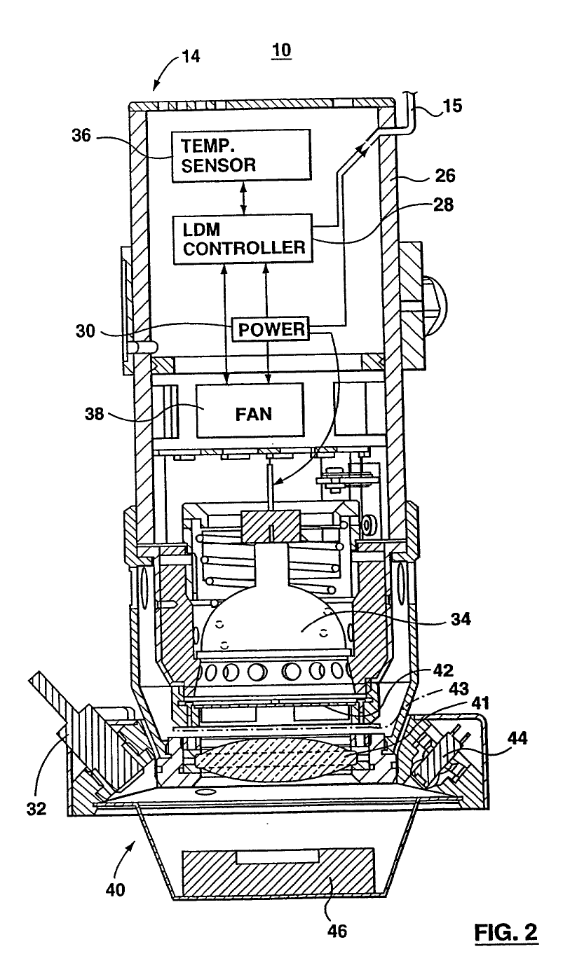

Preferably the LDM 14 also includes a targeting system including three low-power visible lasers 44 (one of which is visible in FIG. 2) aligned such that their beams intersect at the focal point of the light source 34. Such a targeting capability is useful, (especially when the filter's 42 spectral passband is entirely in the infrared) since the infrared radiation emitted by the LDM 14 is invisible. The targeting lasers 44 are preferably detachably mounted to the LDM housing 26.

Additionally, the LDM 14 preferably has a detachable radiometry system 46 configured to monitor the power level of the radiation generated by the light source 34 for calibrating the LDM 14 and confirming that the LDM 14 is delivering the expected quantity of energy to the curable material 100. Preferably the radiometry system 46 is sufficiently compact such that it may be removed without affecting the workpiece 102. As will be understood, the radiometry system 46 is mounted to the housing 26 at periodic intervals for calibrating the LDM 14, but is removed when curing is to be conducted (as illustrated in FIG. 1).

As will be understood, the LDM controller 28 is also operatively coupled to the internal temperature sensor 36 and controls the operation of the fan 38 to maintain the internal temperature of the LDM 14 including the light source 34, within acceptable operating parameters.

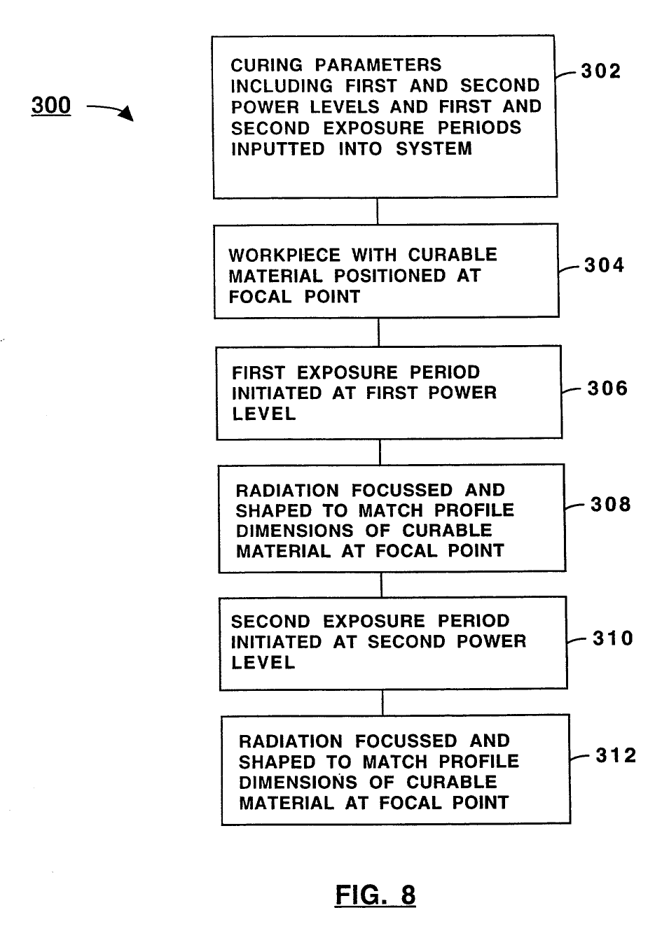

The LDM controller 28, comprising a central processing unit and memory as will be understood, is programmed to control the power of radiation emitted by the system 10 during the cure cycle. The LDM controller 28 may be programmed to effect a multi-step cure, described in greater detail below, with reference to FIG. 8.

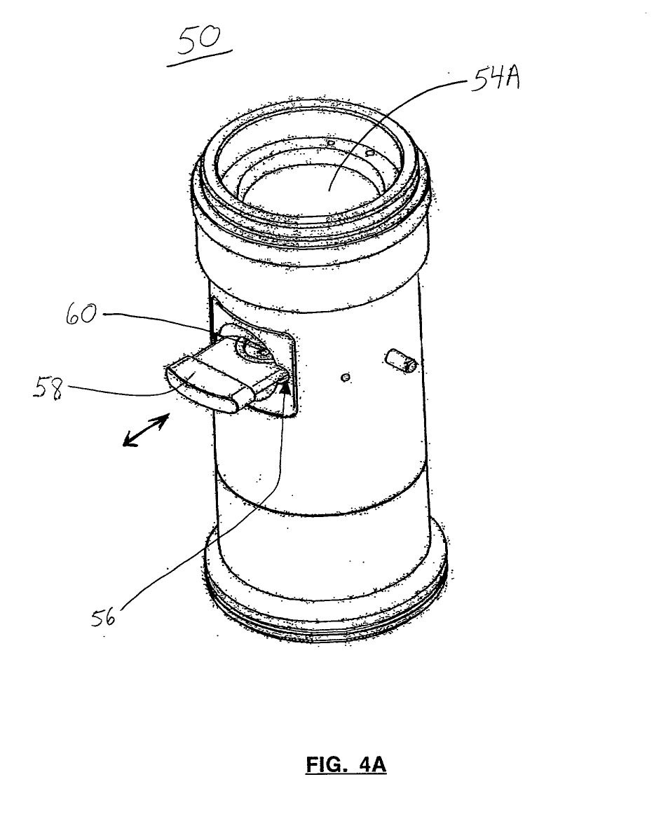

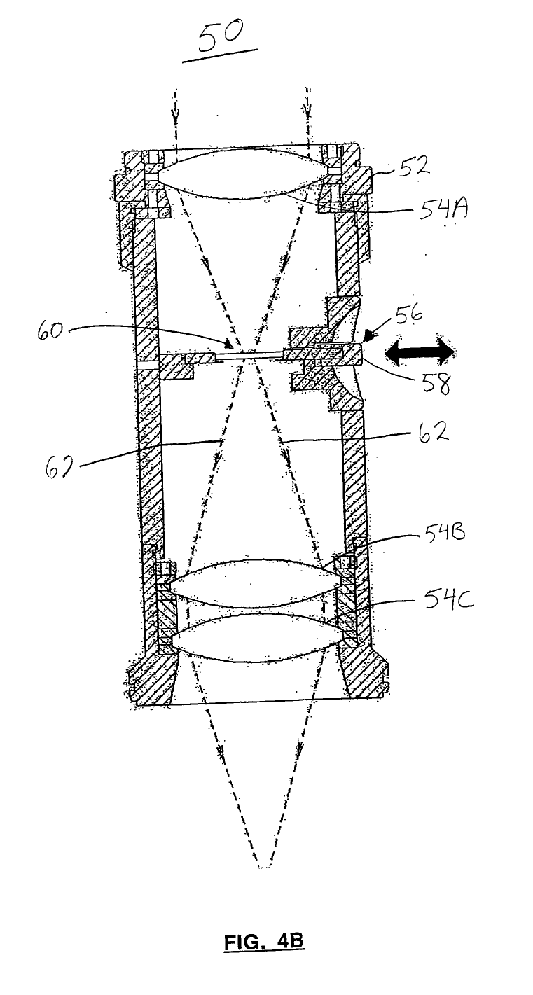

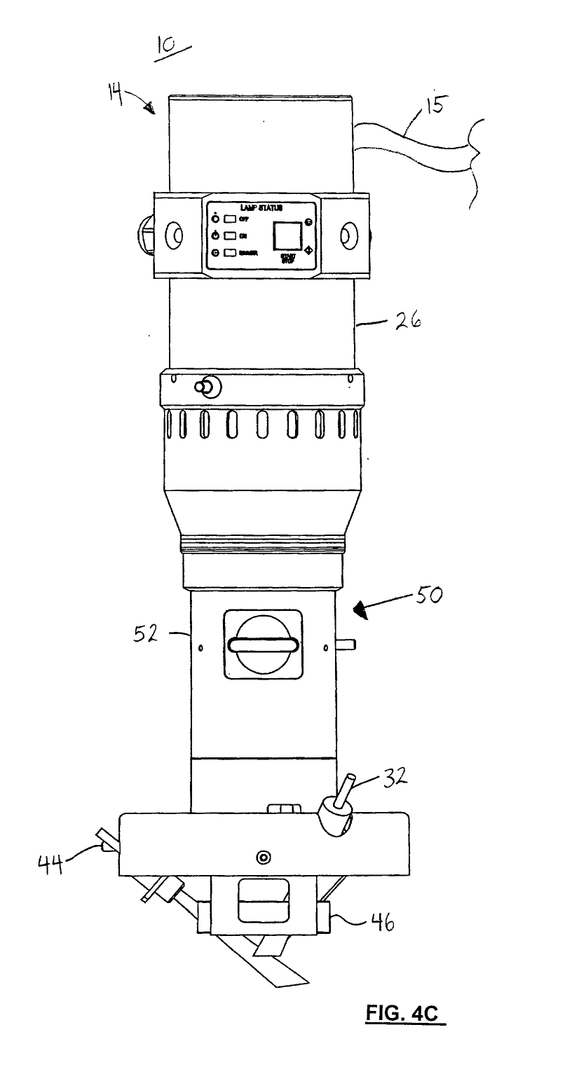

As illustrated in FIGS. 4A and 4B, preferably the curing system 10 also includes an optional lens and masking unit, shown generally as 50. The lens unit 50 has a unit housing 52, containing a substantially hollow interior and a series of three lenses 54A, 54B, 54C in optical alignment. Preferably the lenses 54A, 54B, 54C are made of calcium fluoride which is capable of transmitting a broad range of infrared wavelengths. To mount the lens unit 50 to the LDM 14, the non-contact temperature sensor 32, lens assembly 41, targeting laser system 44, and radiometer 46 must be detached from the LDM housing 26. As illustrated in FIG. 4C, the lens unit 50 is then mounted to the LDM housing 26, typically by threaded engagement, as will be understood. The non-contact temperature sensor 32, targeting laser system 44, and radiometer 46 may then be mounted to the lower end of the lens unit 50, if desired.

The lens unit 50 also includes a mask engaging slot 56 for receiving and aligning an interchangeable mask 58 having a shaped aperture 60 located proximate the focal point of the first lens 54A through which the radiation (represented by dotted light rays 62) generated by the light source 34 passes. As will be understood, the shape of the aperture 60 dictates the shape of the beam of radiation emitted by the lens unit 50. Typically, the size and shape of the aperture 60 are selected such that the size and shape of the radiation 62 substantially match the profile dimensions of the curable material 100 when the radiation 62 reaches the work site. As a result, less radiation is directed collaterally onto the workpiece 102 (including any component being adhered to the workpiece by the curable material 100), reducing the possibility of exceeding the thermal limits of the workpiece 102 which could damage it.

As will be understood, for many curing applications the aperture 60 in the mask 58 may be circular, rectangular or other simple shape. However, the aperture 60 may have a more complex shape or pattern to match the configuration of the curable material 100 on the workpiece 102. For example, for some applications the aperture 60 may have multiple holes corresponding to multiple portions of curable adhesive for simultaneously adhering several components to the workpiece 102. As well, to improve the uniformity of the, the mask 58 may be selected such that size of the mask 58 corresponds to the FWHM (full width at half the maximum peak power) of the beam of radiation when it reaches the reactive material 100.

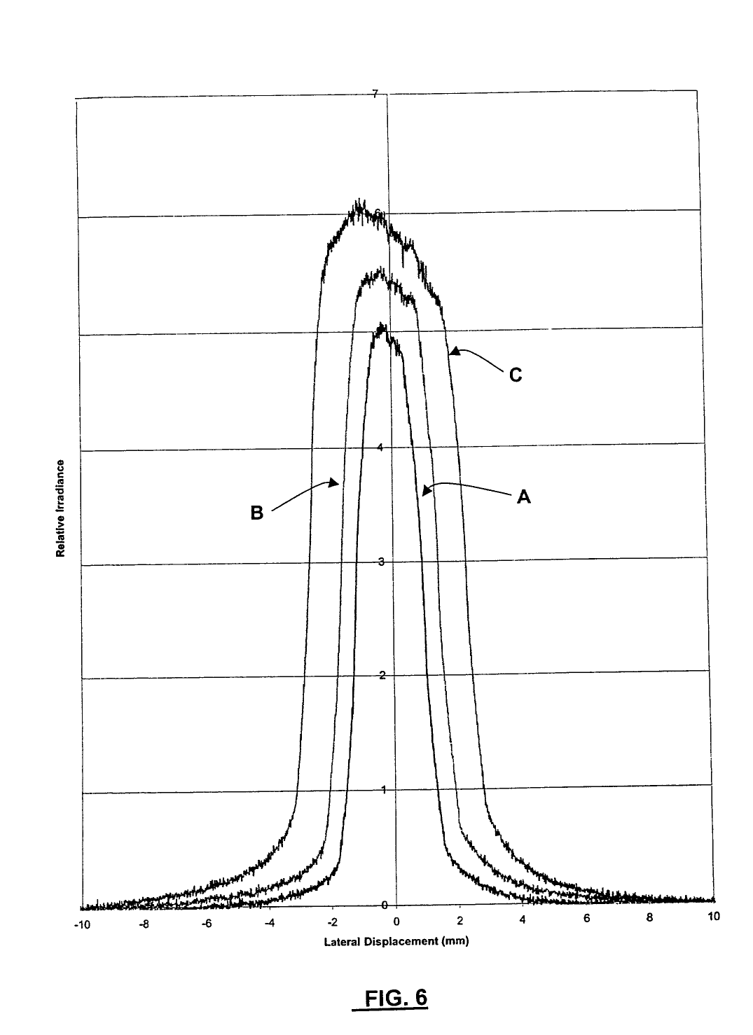

Referring briefly to FIG. 6, illustrated therein is a graph showing the beam profiles of radiation from the identical light source 34 passing through circular apertures 60 of varying diameters: 2 mm (line A), 3 mm (line B) and 5 mm (line C). As can be seen from the graph, the peak irradiance of the radiant energy is affected to only a small degree by changes in the aperture 60 size. As well, as illustrated in the graph, the precise alignment of the aperture with the optical axis of the lenses 54A, 54B, 54C enables a relatively sharp beam profile at the focal point.

Preferably, the components of the system 10 (including the emitter assembly 40 and/or the lens unit 50) are configured to ensure that a substantial portion of the emitted radiation reaches or impinges onto the curable material 100. More preferably, the components of the system are configured such that the quantity of emitted radiation impinging on the curable material 100, as compared to the remainder of the workpiece 102 (and any component being adhered to the workpiece 102 by the curable material 100), is maximized. Preferably, the mask 58 is sized such that at least 10% of the emitted radiation impinging on the workpiece 102 impinges directly on the curable material 100. More preferably, the mask 58 is sized such that at least 50% of the emitted radiation impinging on the workpiece 102 impinges directly on the curable material 100. Most preferably, the mask 58 is sized such that at least 90% of the emitted radiation impinging on the workpiece 102 impinges directly on the curable material 100.

As will be understood, the system 10 enables radiation to be directed onto the curable material 100, while minimizing the amount of radiation directed onto the workpiece 102. As a result, the curable material 100 may be quickly and efficiently cured in accordance with curing parameters specific to the curable material 100, with reduced risk of causing thermal damage to the workpiece 102 and its components. Correspondingly, the curing cycle for the present invention typically requires less energy and substantially less time than prior art curing techniques which heat the entire workpiece 102 to effect a cure of the curable material.

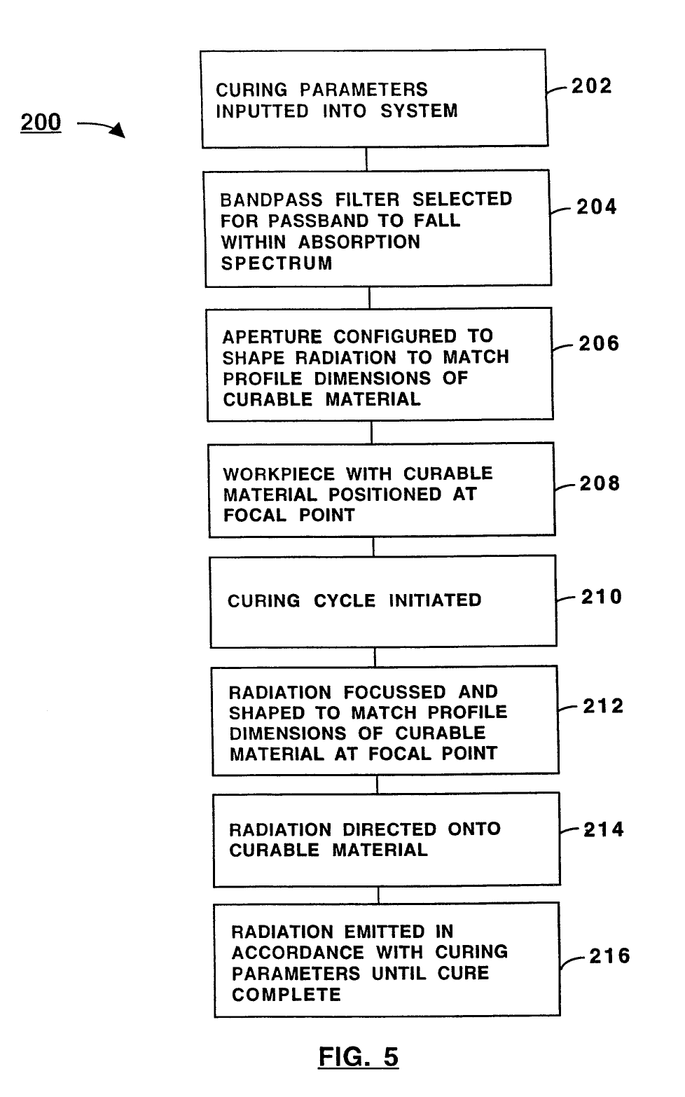

FIG. 5 illustrates the steps of the method 200 carried out by the curing system 10 in use and made in accordance with the subject invention. The user typically first preprograms the system 10 (and specifically the LDM controller 28) using the control data interface 20, with the curing parameters for the curing cycle, such as intensity, temperature and exposure time, correlated to the specific curable material 100 to be cured. (Block 202) Preferably, the filters 42 will be configured to selectively pass radiation within this absorption spectrum. (Block 204) As well, preferably a mask 58 (and more particularly the aperture 60) will be selected to shape the radiation (in cross-section) to approximately match the dimensions (in profile) and position of the curable material 100 on the workpiece 102, in order to minimize the radiation directed onto the remainder of the work piece 102. (Block 206)

The workpiece 102 having the curable material is typically then appropriately positioned at the system's 10 focal point. (Block 208) This positioning step may be carried out by the user manually, using the targeting laser system 44, or will preferably be carried out by an automated manufacturing system using a positioning mechanism such as a conveyor belt 80 (as shown in dotted outline on FIG. 1), manipulator arms or other device, as will be understood. As will be understood, by utilizing an automated positioning mechanism, the system 10 may comprise part of an in-line manufacturing system.

The curing cycle is then initiated with the LDM controller 28 causing the power supply 30 to provide sufficient power to the light source 34 to generate radiation in accordance with the curing parameters (Block 210). This radiation is focused and preferably masked to substantially match the profile dimensions of the curable material at the focal point (Block 212) before being directed onto the curable material 100 by the emitter module 40 (Block 214).

Throughout the curing cycle, the LDM controller 28 controls the amount of radiation emitted by the system 10 in accordance with the inputted curing parameters, until the curing cycle is complete. (Block 216)

FIG. 8 illustrates the steps of a multi-step curing method 300 carried out by the curing system 10 in use and made in accordance with the subject invention. The user typically first preprograms the system 10 (and specifically the LDM controller 28) using the control data interface 20, with the curing parameters for the curing cycle, such as first power level and first exposure time, and a second power level and second exposure time correlated to a curing profile for the specific curable material 100. (Block 302)

The workpiece 102 having the curable material is typically then appropriately positioned at the system's 10 focal point. (Block 304) This positioning step may be carried out by the user manually, using the targeting laser system 44, or will preferably be carried out by an automated manufacturing system using a positioning mechanism such as a conveyor belt 80 (as shown schematically in dotted outline on FIG. 1), manipulator arms or other device, as will be understood. By utilizing an automated positioning mechanism, the system 10 may form part of an in-line manufacturing system.

The curing cycle is then initiated with the LDM controller 28 causing the power supply 30 to provide sufficient power to the light source 34 to generate radiation at the first power level for a period of time equal to the first exposure period (Block 306). This radiation is focused and preferably masked to substantially match the profile dimensions of the curable material at the focal point before being directed onto the curable material 100 (Block 308).

Once the first exposure period has been completed, the LDM controller 28 causes the power supply 30 to vary the power supplied to the light source 34 to generate radiation at the second power level for a period of time equal to the second exposure period (Block 310). This radiation is focused and preferably masked to substantially match the profile dimensions of the curable material at the focal point before being directed onto the curable material 100 (Block 312).

As will be understood, the curing profile used in the multi-step cure for the curable material 100 is typically determined through trial and error testing, and often different reactive materials require different curing profiles. For example, the applicants have determined that to cure 0.1 ml of epoxy Epotek 353 adhesive, directing radiation at 7.2 Watts for 54 seconds, followed by 1.6 Watts for 210 seconds resulted in a consistent and acceptable cure. This curing cycle can be contrasted with a single step curing cycle of 2.4 Watts which also achieved an acceptable cure (of 0.1 ml of Epotek 353), but required an exposure time of 60 minutes. A single step curing cycle of 8 Watts for 95 seconds resulted in an inconsistent cure (of 0.1 ml of Epotek 353), with some burning of the adhesive.

As will also be understood by one skilled in the art, while the LDM controller 28 and the master controller 18 have been described as two separate but operatively coupled devices, one single controller may be used in place of the two controllers 28, 18.

Thus, while what is shown and described herein constitute preferred embodiments of the subject invention, it should be understood that various changes can be made without departing from the subject invention, the scope of which is defined in the appended claims.

We claim:

1. A system for curing curable material, the system comprising:
(a) a generator capable of generating radiation within the absorption spectrum of the curable material;
(b) an emitter adapted to focus the generated radiation and emit said focused radiation onto the reactive material;
(c) a power supply operatively coupled to the generator; and
(d) a controller adapted to control the amount of power supplied to the generator.

2. The system as claimed in claim 1, wherein the generator is capable of generating radiation substantially falling within the wavelength range between about 0.4 and 10 micrometers.

3. The system as claimed in claim 1, wherein the focused radiation substantially falls within the wavelength range between about 3 and 5 micrometers.

4. The system as claimed in claim 1, further comprising a temperature sensor capable of detecting the temperature of the reactive material and generating temperature data signals correlated to the detected temperature and wherein the controller is configured to receive the temperature data signals.

5. The system as claimed in claim 1, further comprising means responsive to the controller for varying the power of radiation emitted by the emitter.

6. The system as claimed in claim 5, wherein the controller is adapted to vary the power of radiation emitted by the emitter in accordance with a curing profile correlated to the curable material.

7. The system as claimed in claim 1, further comprising means for ensuring that a significant portion of the emitted radiation is directed onto the curable material.

8. The system as claimed in claim 7, wherein at least 90% of the emitted radiation impinges upon the curable material.

9. The system as claimed in claim 1, wherein the emitter further comprises a mask for shaping the cross-sectional beam profile of the emitted radiation.

10. The system as claimed in claim 9, wherein the mask is interchangeable.

11. The system as claimed in claim 9, wherein the cross-sectional beam profile of the shaped radiation substantially matches the dimensions of the curable material when said shaped radiation reaches the curable material.

12. The system as claimed in claim 1, wherein the emitter further comprises a bandpass filter for selectively filtering out radiation and emitting radiation substantially within a selected wavelength range.

13. The system as claimed in claim 1, further comprising detection means for detecting the degree of cure of the curable material and for generating data signals correlated to the detected degree of cure and wherein the controller is configured to receive the degree of cure data signals.

14. A manufacturing system comprising:
(a) a curing system as claimed in claim 1 having a focal point for the emitted radiation,
(b) a positioning mechanism adapted to position a workpiece comprising the curable material such that the curable material is substantially at the focal point.

15. A method for curing reactive material, the method comprising the steps of:
(a) generating radiation within the absorption spectrum of the reactive material;
(b) focusing the generated radiation; and
(c) emitting said focused radiation onto the reactive material.

16. The method as claimed in claim 15, further comprising the step of shaping the cross-sectional profile of the emitted radiation to substantially match the shape of the reactive material.

17. The method as claimed in claim 15, further comprising the step of varying the power of the emitted radiation to substantially match a curing profile of the reactive material.

18. The method as claimed in claim 15, wherein the generated radiation substantially falls within the wavelength range between about 0.4 and 10 micrometers.

19. The method as claimed in claim 15, wherein the focused radiation substantially falls within the wavelength range between about 3 and 5 micrometers.

20. A method for curing reactive material, the method comprising the steps of:
(a) generating radiation within the absorption spectrum of the reactive material;
(b) shaping the emitted radiation to substantially match the profile dimensions of the reactive material; and
(c) emitting said shaped radiation onto the reactive material.

21. The method as claimed in claim 20, wherein the generated radiation substantially falls within the wavelength range between about 0.4 and 10 micrometers.

22. The method as claimed in claim 20, wherein the focused radiation substantially falls within the wavelength range between about 3 and 5 micrometers.

23. A method for curing reactive material, the method comprising the steps of:
(a) generating radiation;
(b) directing radiation at a first power level onto the reactive material for a first period of time; and
(c) directing radiation at a second power level onto the reactive material for a second period of time.

24. The method as claimed in claim 23, wherein the radiation is within the absorption spectrum of the reactive material.

25. The method as claimed in claim 23, wherein the first power level and the second power level are preselected to correlate to a curing profile for the reactive material.

26. The method as claimed in claim 25, wherein the first period of time and the second period of time are preselected to correlate to a curing profile for the reactive material.
